(19) United States
(12) Patent Application Publication
(10) Pub. No.: US 2012/0045049 A1
(43) Pub. Date: Feb. 23, 2012

(54) SELF-ORGANIZING DIRECTORY DISPLAY

(75) Inventor: John H. Yoakum, Cary, NC (US)

(73) Assignee: AVAYA, INC., Basking Ridge, NJ (US)

(21) Appl. No.: 12/858,033

(22) Filed: Aug. 17, 2010

(51) Int. Cl. H04M 3/42

(52) U.S. Cl. 379/218.01

(57) ABSTRACT

A method and communications device for displaying a contacts directory to a user. A contacts directory comprising a plurality of contact entries is maintained. Each contact entry includes a corresponding contact identifier and a corresponding contact address. A communication metric is maintained for at least some of the plurality of contact entries based on communication interactions via the corresponding contact address of the contact entry. A request to display the contacts directory is received. The contact identifiers are ordered in an order based at least in part on the communication metric. At least a portion of the plurality of contact identifiers is displayed on a display in the order.

### FIELD OF THE DISCLOSURE

Embodiments disclosed herein relate to the display of a contacts directory, and in particular to displaying the contacts directory to a user based on communication interactions with entities identified in the contacts directory.

### BACKGROUND

Many communications devices, such as mobile phones, allow a user to create a contacts directory containing contact information, such as a contact name and a contact telephone number, that identifies individuals or entities with whom the user may wish to communicate. The communications device typically includes a mechanism for initiating communication with an individual identified in the contacts directory without having to enter the individual's communication address, such as a telephone number. This simplifies communications for the user because it is typically easier for a user to remember the name of an individual than it is to remember the particular communication address by which the individual may be contacted.

It is not uncommon for a contacts directory to grow over time to include hundreds, or even thousands, of contact entries. Moreover, many devices enable contact directories to be imported from multiple other devices, making it increasingly easy to accumulate large numbers of contact entries in a contacts directory. Traversing through hundreds of contact entries in order to initiate a call with an individual can require concentration, dexterity, and time.

For many users, the vast majority of communications are with a relatively small number of individuals. In order to locate one such individual, a user may need to initiate a display of the contacts directory, attempt to remember exactly how the individual is identified in the contacts directory (e.g., nickname, first name, last name), and traverse through an alphabetical listing of the contact entries to locate the correct individual. Some devices allow a user to designate certain contacts as “favorites.” In practice, a contact who is a favorite today may not be a favorite tomorrow. Thus, while a “favorites” list can be useful, it is based on an arbitrary designation by the user and is not necessarily reflective of the actual communication habits of the user. Accordingly, there is a need for providing a contacts directory in an order based on actual communication interactions with individuals, so that the contacts displayed to a user are most likely to be those contacts with whom the user desires to speak.

### SUMMARY

Embodiments herein relate to displaying a contacts directory in an order based on communication interactions with parties identified in the contacts directory. In one embodiment, communication metrics are maintained for contact entries of the contacts directory based on communication interactions with the parties that correspond to the contact entries. Each contact entry includes a contact identifier and a contact address. The contact identifier may be, for example, a textual identifier that identifies a party which whom the user may wish to communicate, such as the name of an individual or business entity (e.g., “John Smith” or “Papa Johns”). The contact address identifies an address via which a communication interaction, such as a telephone call, may be conducted.

One or more communication metrics are maintained for contact entries based on communication attributes of communication interactions with the corresponding contact. A communication metric may comprise any of a multitude of different metrics, such as, for example, total talk time with a contact, total incoming calls from a contact, total outgoing calls to a contact, total incoming calls from a contact that were actually accepted by the user of the communications device, average talk time with a contact, and the like.

Communication attributes are those attributes of a communication interaction that are used to maintain the communication metric, and may include, for example, in the case of a voice call, whether an attempted communication interaction actually resulted in the establishment of a session, whether the communication interaction was initiated by the user of the communications device or by the contact, the total length of the communication interaction, and the like.

Upon receipt of a request from the user to display the contacts directory, the communications device displays at least a portion of the contact identifiers for the contact entries in an order of the communication metric. The communications device may maintain the contact entries in the order of the communications metric continually, or may order the contact entries in the order of the communication metric upon request by the user to display the contacts directory.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a block diagram of a system in which embodiments disclosed herein may be practiced;

FIG. 2 is an illustration of an exemplary communications device;

FIG. 3 is an illustration of the exemplary communications device illustrated in FIG. 2 after the user has selected the contacts directory icon;

FIG. 4 is an illustration of the communications device illustrated in FIG. 2 and FIG. 3 after the user has selected the DIRECTORY BY TALK TIME icon;

FIG. 5 is a flowchart illustrating an exemplary process for displaying the contact identifiers in an order of a communication metric according to one embodiment;

FIG. 6 is a block diagram of a portion of an exemplary contacts directory according to one embodiment;

FIG. 7 illustrates additional exemplary communication metric data and another embodiment for associating the communication metric data with a contact entry;

FIG. 8 illustrates another exemplary communications device wherein the user interface displays the communication metric values that were the bases of the order of the contact identifiers in association with the corresponding contact identifiers;

FIG. 9 is an illustration of the communications device illustrated in FIG. 8 after the user has selected the DIRECTORY BY NUM CALLS icon;

FIG. 10 is an illustration of the communications device after the user has selected the DIRECTORY BY NUM CALLS icon, as illustrated in FIG. 9, wherein the user interface displays the communication metric values that were the bases of the order of the contact identifiers in association with the corresponding contact identifiers;

FIG. 11 is an exemplary user interface by which the user may configure the display of contact identifiers in a desired order;

FIG. 12 is an illustration of an exemplary communications device wherein the user has specified that the user interface should only display a particular number of contact identifiers in the desired order;

FIG. 13 illustrates another embodiment wherein the communications device maintains a plurality of different communication metrics for each contact identifier, and the communication metric used to order and display the contact identifiers is user selectable;

FIG. 14 illustrates an exemplary communications device according to one embodiment; and

FIG. 15 is an exemplary block diagram of a system which includes a communications server.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Embodiments disclosed herein relate to displaying a contacts directory on a communications device in an order based on communication interactions with parties identified in the contacts directory. In this manner, a user is presented with a plurality of contact identifiers based on an order determined by actual communication habits of the user of the communications device with contacts identified in the contacts directory. For purposes of illustration, embodiments will be discussed herein in the context of a mobile phone and voice communication interactions, but the principles described herein have applicability to other communications devices, such as computers, personal digital assistants (PDAs), landline telephones, and the like, and to other types of communication interactions, including, for example, instant message (IM) communication interactions.

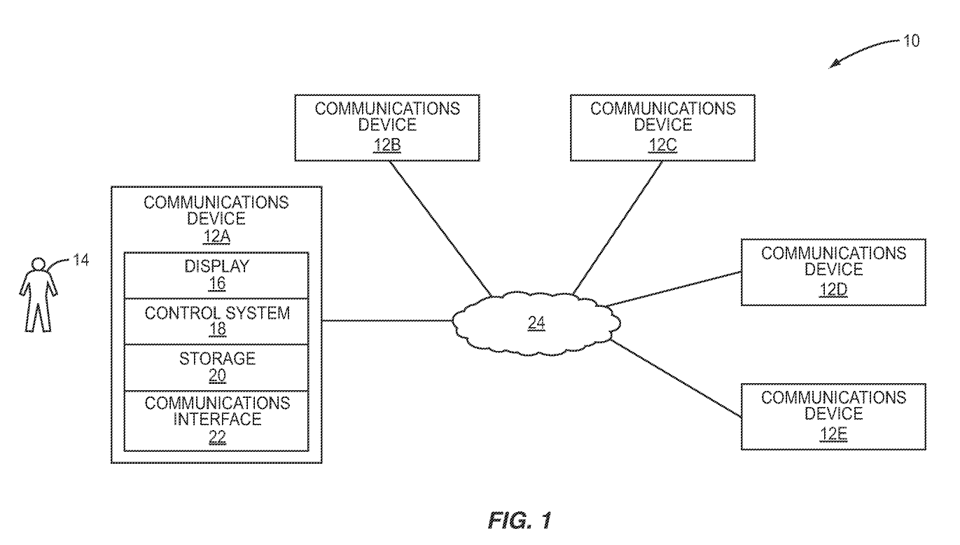

FIG. 1 is a block diagram of a system 10 in which embodiments disclosed herein may be practiced. The system 10 includes a plurality of communications devices 12A-12E (generally, communications device 12 or communications devices 12) via which a user 14 may communicate with one or more individuals or entities. The communications device 12A may include, for example, a display 16, a control system 18 including a central processing unit and a memory, a storage 20, and a communications interface 22. The communications devices 12B-12E may have similar or identical elements. The communications devices 12 may comprise any suitable communications devices, such as mobile phones, landline phones, computers, or the like. The communications devices 12 may communicate via one or more networks 24, which may comprise, for example, a public or proprietary telecommunications network; a proprietary enterprise communications network; a public communications network, such as the Internet; a local area network; or any combination thereof.

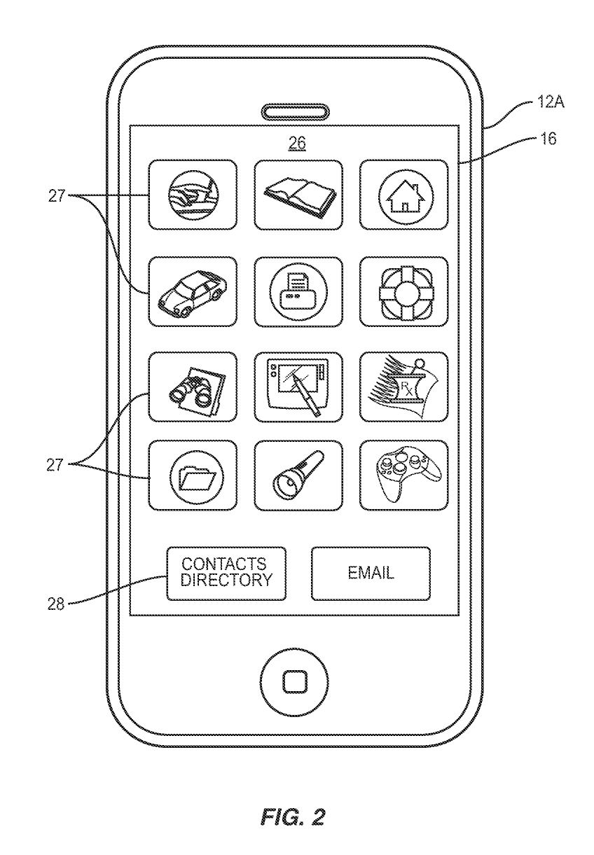

FIG. 2 is an illustration of an exemplary communications device 12A. A user interface 26 is displayed on the display 16, and includes a plurality of program icons 27. The user interface 26 also includes a contacts directory icon 28, which, when selected by the user 14, displays the contacts directory of the communications device 12A.

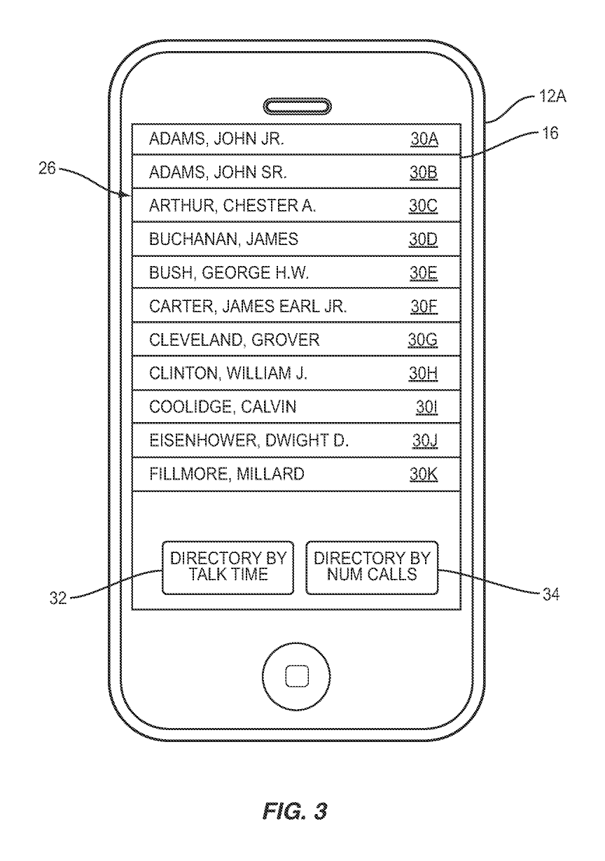

FIG. 3 is an illustration of the exemplary communications device 12A illustrated in FIG. 2 after the user 14 has selected the contacts directory icon 28 (illustrated in FIG. 2). The user interface 26 now includes a plurality of contact identifiers 30A-30K (generally, contact identifier 30 or contact identifiers 30), displayed in alphabetical order. Each contact identifier 30 comprises a textual description of a contact (sometimes referred to herein as a party) stored in the contacts directory of the communications device 12A. Contact entries in the contacts directory typically include a respective contact identifier 30 and a contact address (not illustrated) identifying an address by which the party that corresponds to the contact entry may be contacted. For example, a contact address may comprise a telephone number. While for purposes of illustration contact identifiers 30 are depicted herein as textual identifiers, the contact identifiers 30 may comprise any suitable data that distinguishes one contact from another, including for example, text, an icon, an image, or the like, or any combination thereof.

The user interface 26 also includes icons which direct the communications device 12A to display the contact identifiers 30 in an order of a particular communication metric. For example, a DIRECTORY BY TALK TIME icon 32 may be selected by the user 14 to cause the communications device 12A to display the contact identifiers 30 in an order based on an amount of time the communications device 12A has engaged in communication interactions, i.e., in this example, telephone calls, via the contact addresses that correspond to the contact identifiers 30.

The user interface 26 also includes a DIRECTORY BY NUM CALLS icon 34, which, when selected by the user 14, causes the communications device 12A to display the contact identifiers 30 in an order based on another communication metric, specifically, a number of communication interactions the communications device 12A has had via the contact addresses that correspond to the contact identifiers 30.

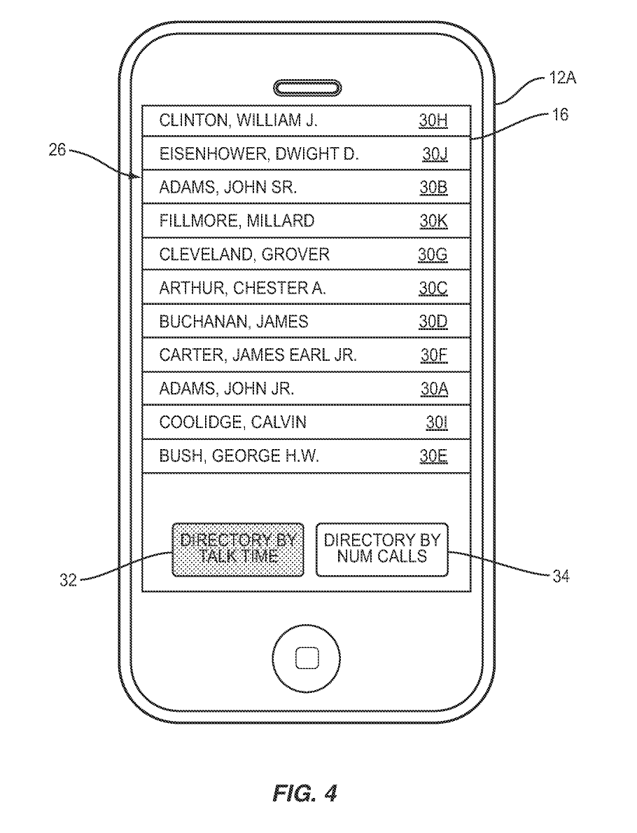

FIG. 4 is an illustration of the communications device 12A illustrated in FIG. 2 and FIG. 3 after the user 14 has selected the DIRECTORY BY TALK TIME icon 32. The user interface 26 now includes the plurality of contact identifiers 30A-30K displayed in an order based on an amount of time the communications device 12A has engaged in communication interactions via the contact addresses that correspond to the contact identifiers 30. For example, the total duration of communication interactions via the contact address that corresponds to the contact identifier 30H is greater than the total duration of communication interactions via the contact address that corresponds to the contact identifier 30J. In particular, if it is assumed that each communication interaction comprises a telephone call, and each telephone call was between the user 14 and the party identified by the corresponding contact identifier 30, then the user 14 spent more time talking with William J. Clinton than with Dwight D. Eisenhower.

Embodiments herein order the contacts directory based on the actual communication interactions of the communications device 12A, and thereby enable the user 14 to quickly and intuitively view a display of those contacts with whom the user 14 is most likely to desire to engage in communications based on previous communication interactions.

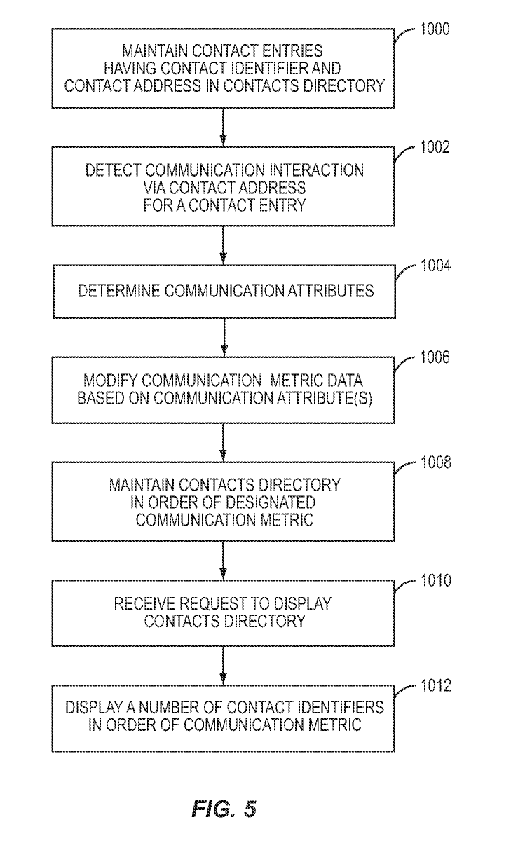

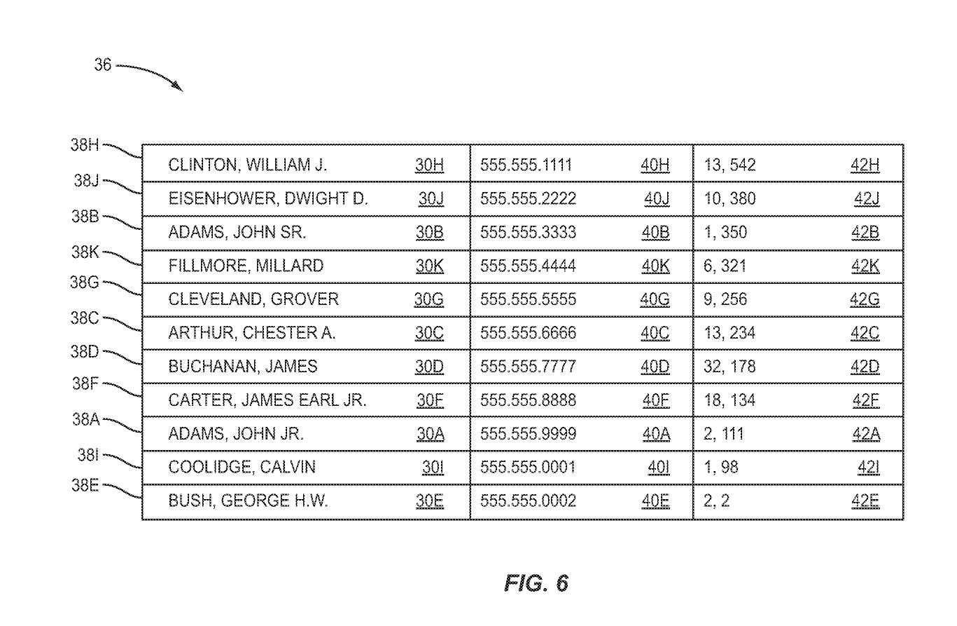

FIG. 5 is a flowchart illustrating an exemplary process for displaying the contact identifiers 30 in an order of a communication metric according to one embodiment. FIG. 6 is a block diagram of a portion of an exemplary contacts directory 36 according to one embodiment. FIGS. 5 and 6 will be discussed together. Initially, the user 14 adds or otherwise maintains a plurality of contact entries 38 (generally, contact entry 38 or contact entries 38), such as contact entries 38A-38K, into the contacts directory 36 on the communications device 12A manually, with the aid of software, or in any other desired manner (FIG. 5, step 1000). While eleven contact entries 38 are illustrated, the contacts directory 36 may contain hundreds, or thousands, of contact entries 38. FIG. 6 illustrates contact entries 38A-38K, each of which has a corresponding contact identifier 30A-30K that identifies a contact, or party, and a corresponding contact address 40A-40K (generally, contact address 40 or contact addresses 40) via which the communications device 12A may contact the corresponding party. As discussed previously, the example provided herein relates to voice communication interactions using telephone numbers, and thus the contact addresses 40 comprise telephone numbers, but the contact addresses 40 may comprise other types of contact addresses, such as instant message addresses, session initiation protocol (SIP) addresses, Internet protocol (IP) addresses, or the like. Similarly, for purposes of illustration, communication interactions are assumed to be telephone calls, but embodiments described herein may include other types of communication interactions, such as instant message communication interactions and the like.

The communications device 12A detects, or determines, a communication interaction via a contact address 40 that corresponds to a contact entry 38 (step 1002). In the case of a telephone call, the communication interaction may be detected or determined because the communications device 12A is attempting to initiate communications via a contact address 40. For example, the user 14 may have initiated a telephone call using the contact address 40H in an attempt to contact William J. Clinton. Alternately, the communications device 12A may receive a call from another communications device 12. The process discussed herein may be limited to communication interactions with communication addresses that correspond to a contact entry 38, or may also include communication interactions with communication addresses which do not correspond to a contact entry 38, such that if one of such communication addresses is subsequently saved as a new contact entry 38, communication metrics for such new contact entry 38 may already exist.

The communications device 12A determines one or more communication attributes associated with the communication interaction (step 1004). The communication attributes may comprise any quantifiable attribute associated with the communication interaction. For example, for a telephone call, communication attributes may include: whether the communication was incoming (received by the communications device 12A) or outgoing (initiated by the communications device 12A); for an incoming call, whether the communication was answered by the user 14 or rejected by the user 14; for an outgoing call, whether the communication was answered by the called party, or whether the communication went unanswered, and/or whether the communication went to the called party's voice mail system; and/or a duration or length of a communication session if the communication was answered by the called party. Those skilled in the art will recognize that the communication attributes provided herein are merely exemplary and that embodiments are not limited to such communication attributes.

Other communication attributes may be determined for other types of communication interactions. For example, for IM communication interactions, communication attributes can include the fact that an IM was sent or received by the communications device 12A, the text size of an IM, the number of messages in a succession of interactions within a desired timeframe, a total number of interactions, a length of time since the previous interaction, or the like.

Communication metric data is then modified based on the determined communication attributes (step 1006). The communication metric data comprises the data used to determine one or more communication metrics. For example, assume that one communication metric used to order the contact identifiers 30 is total talk time of all incoming and outgoing communications (i.e., the cumulative amount of time the communications device 12A has been engaged in communication interactions via a particular contact address 40). In this example, the communication attribute that identifies the total duration of a particular communication interaction may be added to a running total that is maintained for the respective contact entry 38.

The communication metric data may be stored in association with corresponding contact entries 38 in any suitable data structure. Referring to FIG. 6, assume, for example, that each contact entry 38 includes corresponding communication metric data 42 which comprises a total talk time for all communication interactions via a corresponding contact address 40. The communication metric data 42 may also include information regarding the total number of communication interactions via the corresponding contact address 40. For example, the communication metric data 42H indicates that the communications device 12A has had 13 communication interactions via the contact address 40H, for a total duration of 542 minutes. The communication metric data 42J indicates that the communications device 12A has had 10 communication interactions via the contact address 40J, for a total duration of 380 minutes. Keeping communication metric data 42 for multiple communication metrics may be desirable so that the contact identifiers 30 may be ordered based on the multiple communication metrics. For example, if desired, the contact identifiers 30 could be ordered not only by total talk time, but by average talk time, because communication metric data identifying both the number of communication interactions and the total talk time is maintained in the contacts directory 36.

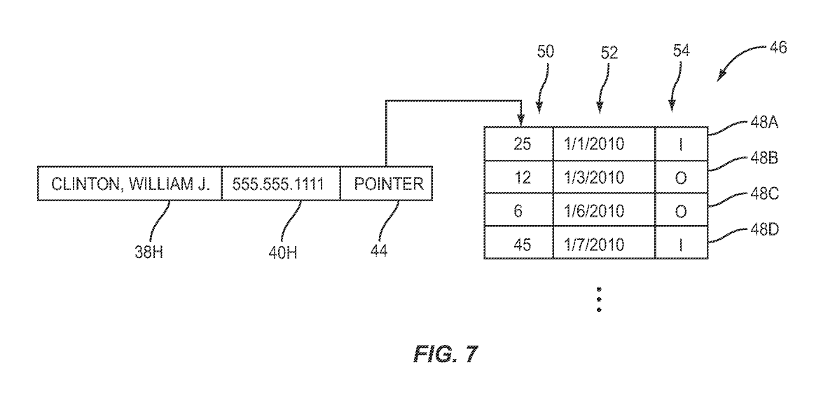

FIG. 7 illustrates additional exemplary communication metric data 42 and an alternate way of associating the communication metric data 42 with a contact entry 38 (such as the contact entry 38H) from that illustrated in FIG. 6. FIG. 7 will be discussed in conjunction with FIG. 5. In this embodiment, each contact entry 38 may have a pointer 44 to an associated communication metric data structure 46. The communication metric data structure 46 includes entries 48A-48D, each of which corresponds to a communication interaction by the communications device 12A via the contact address 40H. The communication metric data structure 46 includes communication attribute information including the total duration of the corresponding communication interaction, as illustrated by the communication attribute data in column 50; the date of the communication interaction, as illustrated by the communication attribute data in column 52; and whether the communication interaction was an incoming communication or outgoing communication from the perspective of the communications device 12A, as illustrated by the communication attribute data in column 54.

The communication metric data contained in the communication metric data structure 46 enables the communications device 12A to order the contact identifiers 30 by a number of communication metrics, including total talk time for incoming calls, total talk time for outgoing calls, total talk time for all calls, average talk time for incoming calls, average talk time for outgoing calls, and average talk time for all calls. The date communication attribute data maintained in column 52 enables the communication metrics to be based on specified time frames, such as, for example, all incoming calls in the past week.

Referring again to FIG. 5, the contact identifiers 30 may be maintained in an order of one or more designated communication metrics (step 1008). For example, the contact identifiers 30 may be resorted after each communication interaction. Alternately, one or more indexes that contain references to the contact identifiers 30 may be maintained in a desired order, and then used to access the contact identifiers 30 in the order of the communication metric upon request.

The communications device 12A receives a request to display the contacts directory (step 1010). For example, the user 14 may select the DIRECTORY BY TALK TIME icon 32 or the DIRECTORY BY NUM CALLS icon 34 (FIG. 3). The communications device 12A then displays on the display 16 a number of the contact identifiers 30 in the order of the communication metric (step 1012). The number of contact identifiers 30 displayed may be configured by the user, determined by the size of the text associated with the contact identifiers 30 and the size of the display 16, or based on other desired criteria. Preferably, the communications device 12A enables the user 14 to easily traverse through all contact identifiers 30 in the order of the communication metric if this is desired by the user 14.

Embodiments are described herein in the context of each contact identifier 30 having a single corresponding contact address 40. However, embodiments disclosed herein are not limited to a single contact address 40, and are applicable to contact identifiers 30 having multiple different contact addresses 40, such as, for example, multiple telephone addresses, multiple IM addresses, and multiple SIP addresses. In such embodiments, the order of the contact identifiers 30 may be based on a function of the communication interactions via multiple different contact addresses 40 for each contact identifier 30. For example, the order of the contact identifiers 30 may be based on a mean of communication interactions via multiple contact addresses 40. The order of the contact identifiers may even be based on a function of different communication metrics for each of the different contact addresses 40 associated with a contact identifier 30.

While embodiments are disclosed herein in the context of ordering the contact identifiers 30 based on a single communication metric, embodiments herein are not limited to a single communication metric, and the display of the contact identifiers 30 may be based on a function of multiple communication metrics that are maintained for each contact identifier 30.

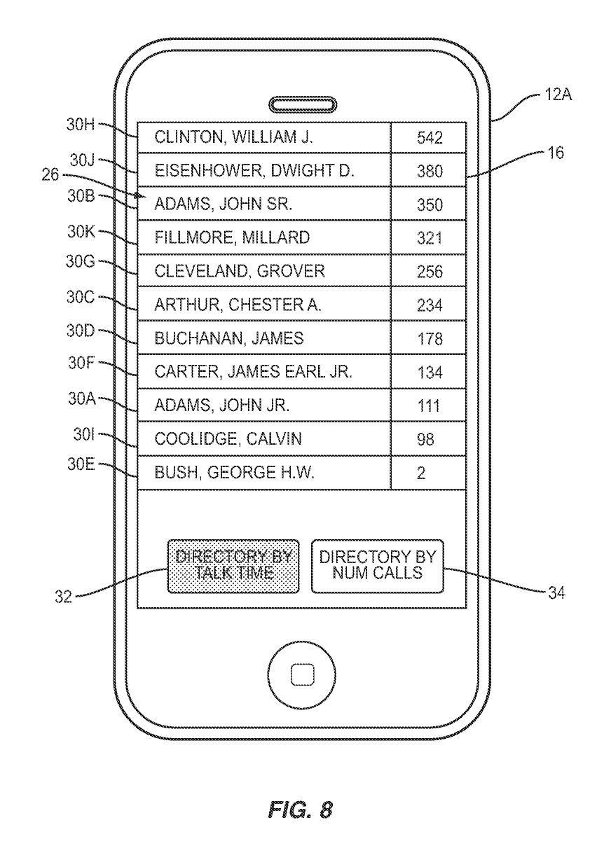

FIG. 8 illustrates another embodiment wherein the user interface 26 may display the communication metric values that were the bases of the order of the contact identifiers 30 in association with the corresponding contact identifiers 30. In this example, the communication metric used by the communications device 12A to order the contact identifiers 30 is the cumulative amount of time the communications device 12A has been engaged in communication interactions via a particular contact address 40 (i.e., total talk time). In addition to displaying the contact identifiers 30 in the desired order, the user interface 26 also displays the value of the communication metric that was used to order the contact identifiers 30. For example, the contact identifier 30H is displayed in association with the value 542, indicating that the communications device 12A has been engaged in communication interactions via the contact address 40H for a total of 542 minutes. The contact identifier 30J is displayed in association with the value 380, indicating that the communications device 12A has been engaged in communication interactions via the contact address 40J for a total of 380 minutes.

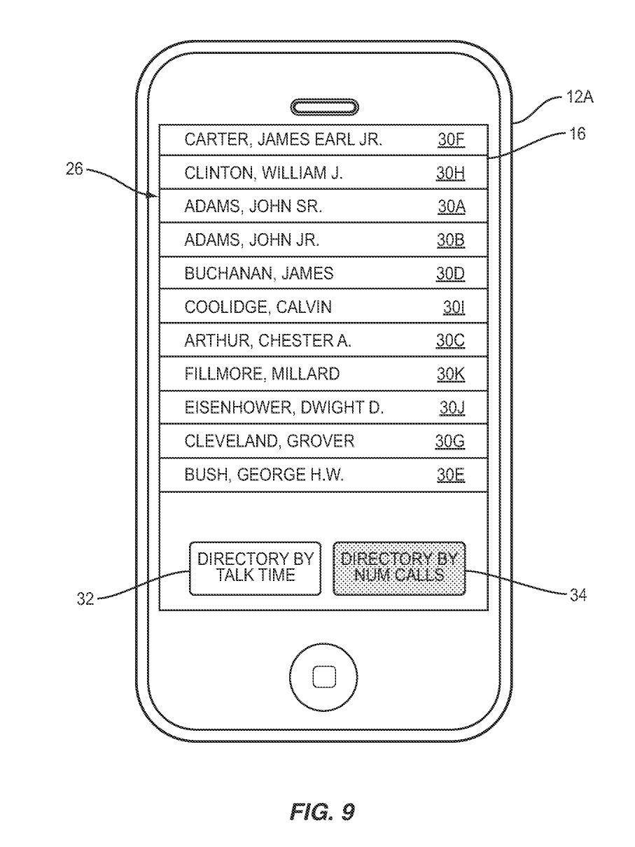

FIG. 9 is an illustration of the communications device 12A after the user 14 has selected the DIRECTORY BY NUM CALLS icon 34. In response to such selection, the user interface 26 may display the plurality of contact identifiers 30A-30K in an order based on a metric that identifies the total number of communication interactions between the communications device 12A and a corresponding contact address 40. For example, the total number of communication interactions via the contact address 40F (which corresponds to the contact identifier 30F) has been greater than the total number of communication interactions via the contact address 40H (which corresponds to the contact identifier 30H). If it is assumed that each communication interaction comprises a telephone call, and each telephone call was between the user 14 and the actual individual identified by the corresponding contact identifier 30, then the user 14 had more telephone calls with James Earl Carter Jr. than with William J. Clinton.

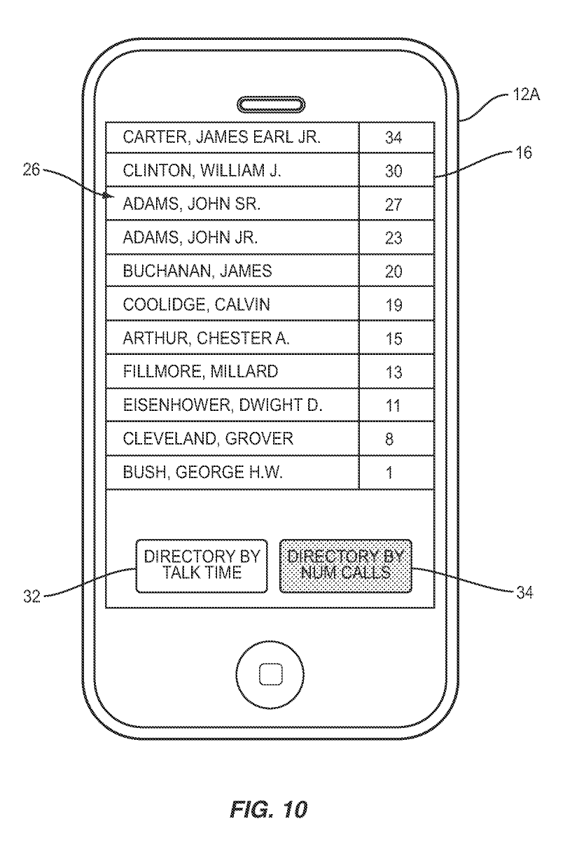

FIG. 10 is an illustration of the communications device 12A after the user 14 has selected the DIRECTORY BY NUM CALLS icon 34, as illustrated in FIG. 9, wherein the user interface 26 displays the communication metric values that were the bases of the order of the contact identifiers 30 in association with the corresponding contact identifiers 30. In this example, the communication metric used by the communications device 12A to order the contact identifiers is the total number of communication interactions between the communications device 12A and a corresponding contact address 40. The user interface 26 indicates that the total number of calls via the contact address 40F was 34 and the total number of calls via the contact address 40H was 30 calls.

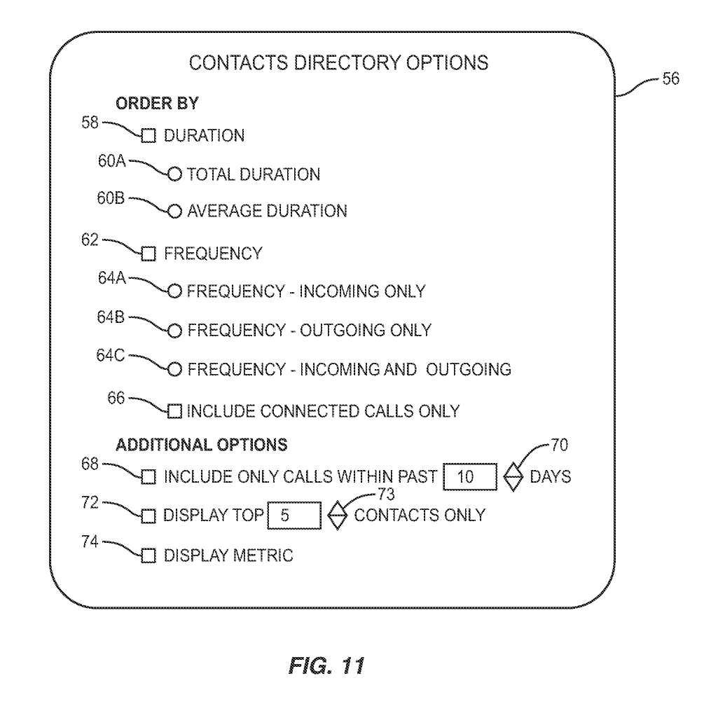

In one embodiment, the user 14 may have an ability to configure the communications device 12 to display the contact identifiers 30 in a desired order based on a selected communication metric and other criteria. FIG. 11 is an exemplary user interface 56 by which the user 14 may configure the display of contact identifiers 30 in a desired order. A duration check box 58 may be selected if the user 14 desires that the contact identifiers 30 be displayable in an order based on a duration of communication interactions (e.g., talk time). A radio button 60A may be selected by the user 14 to indicate that the communication metric will be based on a total duration of communication interactions via corresponding contact addresses 40. A radio button 60B may be selected by the user 14 to indicate that the communication metric will be based on an average duration of communication interactions via corresponding contact addresses 40.

A frequency checkbox 62 may be selected if the user 14 desires that the contact identifiers 30 be displayable in an order based on the frequency of communication interactions via contact addresses 40. A radio button 64A may be selected if the user 14 desires that only incoming calls be used as the basis for determining the frequency of communications. A radio button 64B may be selected if the user 14 desires that only outgoing calls be used as the basis for determining the frequency of communications. A radio button 64C may be selected if the user 14 desires that both incoming and outgoing calls be used as the basis for determining the frequency of communications. The user 14 may select a checkbox 66 to indicate that only calls that have actually been connected be considered in the ordering of the contact identifiers 30. For example, if the checkbox 66 is selected, calls that went to voice mail, or that went unanswered, will not be considered as a communication interaction for purposes of this communication metric.

The user 14 may select the timeframe checkbox 68 to specify that only communication interactions within a particular time frame, such as those communication interactions that took place within the past 10 days, be considered when ordering the contact identifiers 30. A selector 70 may easily enable the user 14 to identify the desired time frame. The user 14 may select the checkbox 72 to specify that the user interface 26 should only display a particular number of contact identifiers 30. A selector 73 may easily enable the user 14 to identify the desired number. The user 14 may select the checkbox 74 to specify that the user interface 26 should display the value of the communication metric used as the basis of the order of the contact identifiers 30 in association with corresponding contact identifiers 30 (as in FIG. 8 and FIG. 10).

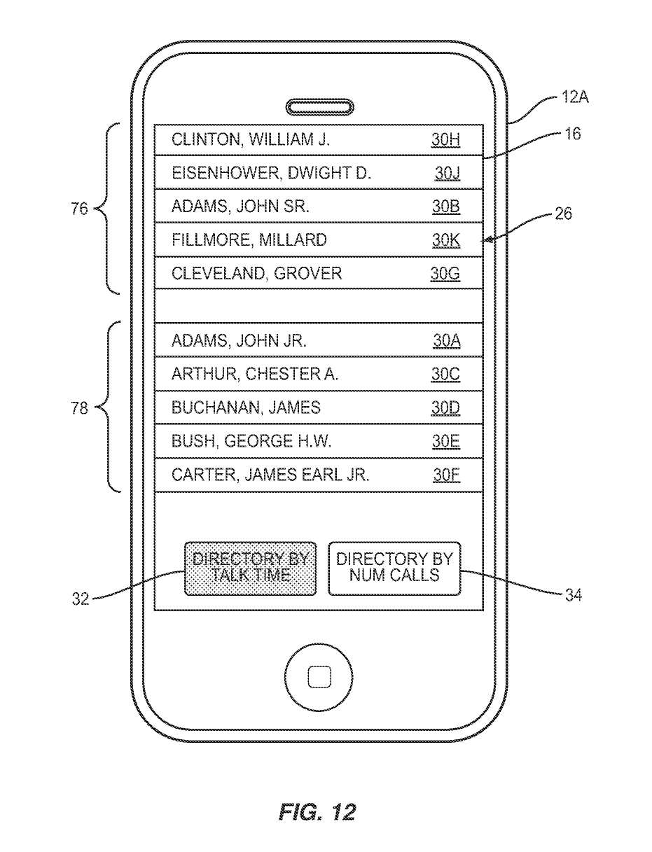

FIG. 12 is an illustration of the communications device 12A wherein the user 14 has specified that the user interface 26 should only display a particular number of contact identifiers 30 in the desired order. In this example, the user 14 has specified that the user interface 26 should display only the top five contact identifiers 30. Thus, the user interface 26 includes a display area 76 in which the top five contact identifiers 30 from the list of contact identifiers 30 based on a total talk time communication metric are displayed. The user interface 26 also includes a display area 78 wherein the rest of the contact identifiers 30 are displayed in alphabetical order.

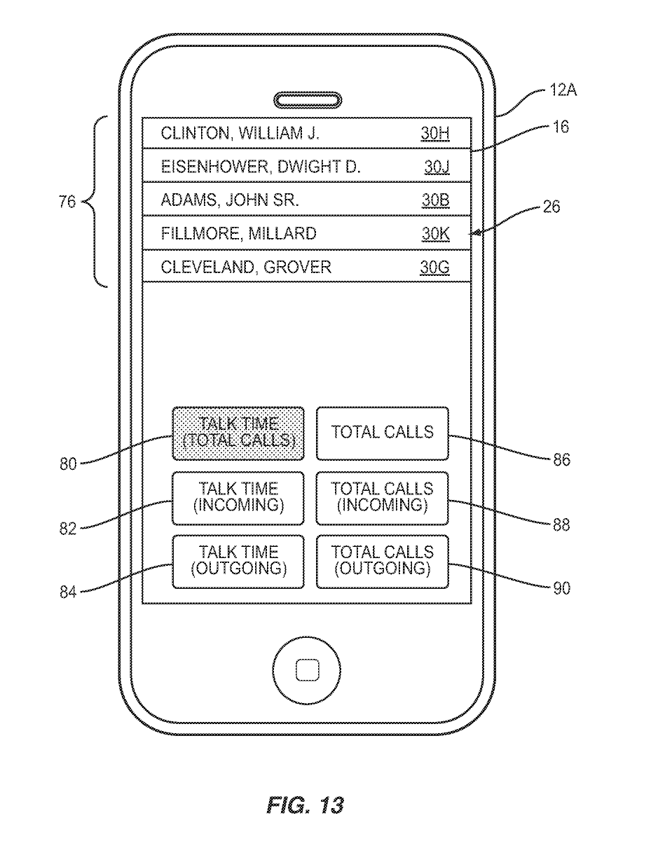

FIG. 13 illustrates another embodiment wherein the communications device 12A maintains a plurality of different communication metrics for each contact identifier 30, and the communication metric used to order and display the contact identifiers 30 is user selectable. The user 14 may select an icon 80 to display the contact identifiers 30 based on a communication metric quantifying the total duration of incoming and outgoing communication interactions between the communications device 12A and corresponding contact addresses 40. The user 14 may select an icon 82 to display the contact identifiers 30 based on a communication metric quantifying the total duration of only incoming communication interactions between the communications device 12A and corresponding contact addresses 40. The user 14 may select an icon 84 to display the contact identifiers 30 based on a communication metric quantifying the total duration of only outgoing communication interactions between the communications device 12A and corresponding contact addresses 40. The user 14 may select an icon 86 to display the contact identifiers 30 based on a communication metric quantifying the total number of incoming and outgoing communication interactions between the communications device 12A and corresponding contact addresses 40. The user 14 may select an icon 88 to display the contact identifiers 30 based on a communication metric quantifying the total number of only incoming communication interactions between the communications device 12A and corresponding contact addresses 40. The user 14 may select an icon 90 to display the contact identifiers 30 based on a communication metric quantifying the total number of only outgoing communication interactions between the communications device 12A and corresponding contact addresses 40.

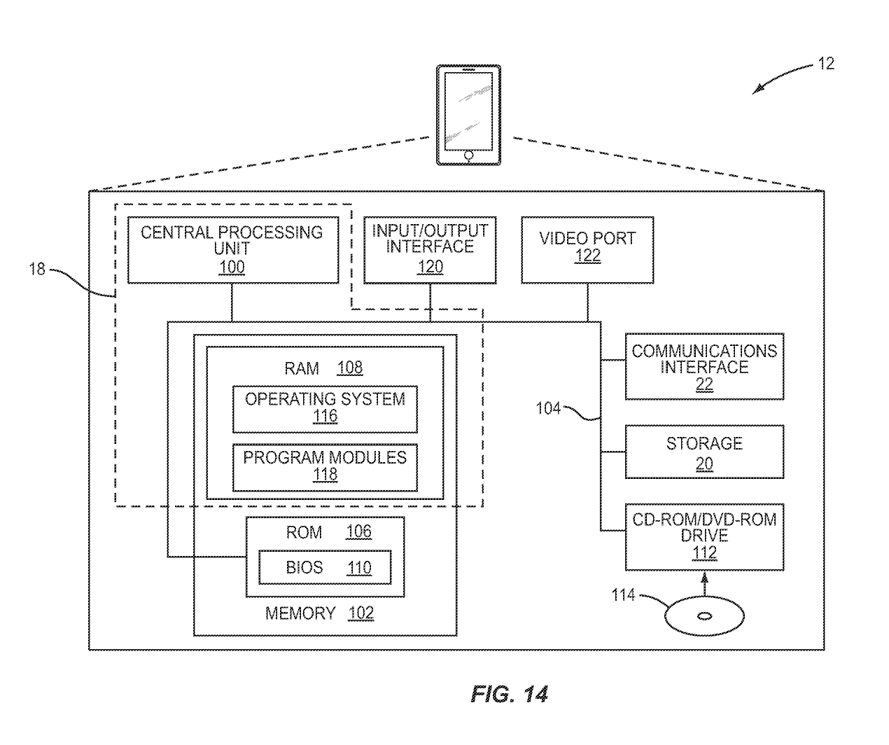

FIG. 14 illustrates an exemplary communications device 12 according to one embodiment. The communications device 12 may, as discussed previously, comprise a mobile phone, a computer, a personal digital assistant, a landline telephone, or the like. In addition to components discussed previously herein, the exemplary communications device 12 may include a central processing unit 100, a system memory 102, and a system bus 104. The system bus 104 provides an interface for system components including, but not limited to, the system memory 102 and the central processing unit 100. The central processing unit 100 can be any of various commercially available or proprietary processors. Dual microprocessors and other multi-processor architectures may also be employed as the central processing unit 100.

The system bus 104 can be any of several types of bus structures that may further interconnect to a memory bus (with or without a memory controller), a peripheral bus, and a local bus using any of a variety of commercially available bus architectures. The system memory 102 can include non-volatile memory 106 (e.g., read only memory (ROM), erasable programmable read only memory (EPROM), electrically erasable programmable read only memory (EEPROM), etc.) and/or volatile memory 108 (e.g., random access memory (RAM)). A basic input/output system (BIOS) 110 can be stored in the non-volatile memory 106, and can include the basic routines that help to transfer information between elements within the communications device 12. The volatile memory 108 can also include a high-speed RAM such as static RAM for caching data.

The communications device 12 may include the storage 20, which may comprise, for example, an internal hard disk drive (HDD) (e.g., enhanced integrated drive electronics (EIDE) or serial advanced technology attachment (SATA)), for storing communication metric data and other information discussed herein. The communications device 12 may further include an optical disk drive 112 (e.g., for reading a CD-ROM or DVD-ROM 114). The drives and associated computer-readable media provide non-volatile storage of data, data structures, computer-executable instructions, and so forth. For the communications device 12, the drives and media accommodate the storage of any data in a suitable digital format. Although the description of computer-readable media above refers to an HDD and optical media such as a CD-ROM or DVD-ROM, it should be appreciated by those skilled in the art that other types of media which are readable by a computer, such as Zip disks, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 108, including an operating system 116 and one or more program modules 118, which implement the functionality described herein, including, for example, determining communication attributes associated with communication interactions, maintaining communication metric data, and ordering and displaying contact identifiers 30 based on communication metrics. It is to be appreciated that the embodiments can be implemented with various commercially available operating systems or combinations of operating systems. All or a portion of the embodiments may be implemented as a computer program product, such as a computer-usable or computer-readable medium having a computer-readable program code embodied therein. The computer-readable program code can include software instructions for implementing the functionality of the embodiments described herein. The central processing unit 100, in conjunction with the program modules 118 in the volatile memory 108, may serve as the control system 18 for the communications device 12 that is configured to, or adapted to, implement the functionality described herein.

A user may be able to enter commands and information into the communications device 12 through one or more wired or wireless input devices, for example, a keyboard and a pointing device, such as a mouse (not illustrated), or via the display 16 where the display 16 is a touch screen. Other input devices (not illustrated) may include a microphone, an infrared (IR) remote control, a joystick, a game pad, a stylus pen, or the like. These and other input devices are often connected to the central processing unit 100 through an input/output interface 120 that is coupled to the system bus 104 but can be connected by other interfaces, such as a parallel port, an IEEE 1394 serial port, a game port, a universal serial bus (USB) port, an IR interface, etc.

The communications device 12 may drive a separate or integral display 16, which may also be connected to the system bus 104 via an interface, such as a video port 122. The communications device 12 operates in a networked environment using a wired and/or wireless network communications interface 22. The communications interface 22 can facilitate wired and/or wireless communications to the network 24 (FIG. 1).

The communications device 12 may be operable to communicate with any wireless devices or entities operatively disposed in wireless communication, for example, a printer, a scanner, or a desktop or portable computer, via wireless technologies, such as Wi-Fi® and Bluetooth®, for example.

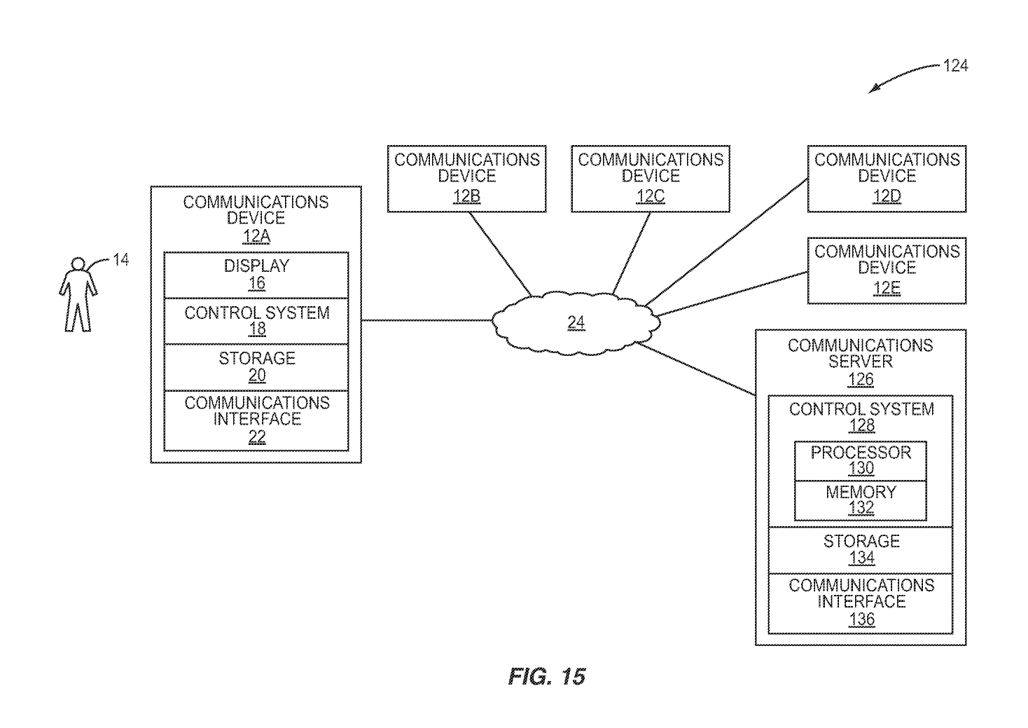

FIG. 15 is an exemplary block diagram of a system 124 which includes a communications server 126. The system 124 depicted in FIG. 15 is similar to the system 10 depicted in FIG. 1, except the contacts directory 36 of the communications device 12A is stored on the communications server 126. The communications server 126 maintains one or more communication metrics for at least some of the plurality of contact entries based on communication interactions via contact addresses 40. In this embodiment, the communications device 12A may send the communications server 126 a request for the contacts directory. For example, the communications device 12A may receive a request from the user 14 to view the contacts directory 36, and responsive to such a request, may send the communications server 126 a request for the contacts directory 36. The communications server 126 orders the plurality of contact identifiers 30 in an order based at least in part on the communication metric and sends the contact identifiers 30 in the order to the communications device 12A. The communications device 12A may then display the contact identifiers 30 to the user 14 in the order.

The communications server 126 may include a control system 128 that includes a processor 130 and a memory 132. The communications server 126 may also include a storage 134, such as a hard disk drive or the like, in which the contacts directory 36, communication metric data, and other relevant information may be stored. A communications interface 136 enables the communications server 126 to communicate via the network 24.

Those skilled in the art will recognize improvements and modifications to the preferred embodiments of the present disclosure. All such improvements and modifications are considered within the scope of the concepts disclosed herein and the claims that follow.

What is claimed is:

1. A computer-implemented method for displaying a directory to a user, comprising:
maintaining, by a communications device, a contacts directory comprising a plurality of contact entries, wherein each of the plurality of contact entries includes a corresponding contact identifier and at least one corresponding contact address;
maintaining, by the communications device, a communication metric for at least some of the plurality of contact entries based on communication interactions via the at least one corresponding contact address;
receiving, by the communications device, a request to display the contacts directory;
ordering, by the communications device, the plurality of contact identifiers in an order based at least in part on the communication metric; and
displaying at least a portion of the plurality of contact identifiers on a display in the order.

2. The method of claim 1, wherein the at least one corresponding contact address comprises a telephone number.

3. The method of claim 1, wherein the at least one corresponding contact address comprises one of an instant message address and a session initiation protocol (SIP) address.

4. The method of claim 1, wherein the communication metric comprises a total duration of all communication interactions via the at least one corresponding contact address.

5. The method of claim 1, wherein the communication metric comprises an average duration of all communication interactions via the at least one corresponding contact address.

6. The method of claim 1, wherein the communication metric comprises a total number of communication interactions via the at least one corresponding contact address.

7. The method of claim 1, wherein the communication metric comprises a total number of incoming communication interactions via the at least one corresponding contact address.

8. The method of claim 1, wherein the communication metric comprises a total number of outgoing communication interactions via the at least one corresponding contact address.

9. The method of claim 1, wherein the method is performed on a mobile phone, the communication interactions comprise telephone calls, and the at least one corresponding contact address comprises a telephone number.

10. The method of claim 1, wherein the communication interactions comprise instant messages and the at least one corresponding contact address comprises an instant message address.

11. The method of claim 1, further comprising receiving a selection by the user of one contact identifier, and initiating a communication interaction via the contact address that corresponds to the one contact identifier.

12. The method of claim 1, further comprising displaying the corresponding communication metric in association with each of the at least a portion of the plurality of contact identifiers to the user in the order.

13. The method of claim 1, wherein the communication metric is maintained only for communication interactions via contact addresses.

14. The method of claim 1, wherein the contact identifiers are ordered in the order based at least in part on the communication metric prior to receiving the request to display the contacts directory.

15. The method of claim 1, further comprising maintaining, by the communications device, a second communication metric for the at least some of the plurality of contact entries based on the communication interactions via the at least one corresponding contact address; and wherein ordering, by the communications device, the plurality of contact identifiers in the order based at least in part on the communication metric further comprises ordering the plurality of contact identifiers in an order based at least in part on the communication metric and the second communication metric.

16. The method of claim 1, wherein the each of the plurality of contact entries includes the corresponding contact identifier and at least two corresponding contact addresses, and wherein maintaining, by the communications device, the communication metric for the at least some of the plurality of contact entries based on the communication interactions via the at least one corresponding contact address further comprises maintaining the communication metric for the at least some of the plurality of contact entries based on communication interactions via the at least two contact addresses that correspond to the at least some of the plurality of contact entries.

17. A method for displaying a directory, comprising:
maintaining a communication metric for each contact entry in a contacts directory based on communication interactions via corresponding contact addresses;
receiving a request to display the contacts directory; and
displaying at least a portion of the contacts directory based on the communication metric.

18. The method of claim 17, wherein the corresponding contact addresses comprise telephone numbers.

19. The method of claim 17, wherein the method is performed on a mobile phone, the communication interactions comprise telephone calls, and the corresponding contact addresses comprise telephone numbers.

20. A communications device, comprising:
a communications interface adapted to communicate with a network; and
a control system comprising a processor and adapted to:
maintain a contacts directory comprising a plurality of contact entries, wherein each of the plurality of contact entries includes a corresponding contact identifier and at least one corresponding contact address;
maintain a communication metric for at least some of the plurality of contact entries based on communication interactions via contact addresses that correspond to the at least some of the plurality of contact entries;
receive a request to display the contacts directory;
order the plurality of contact identifiers in an order based at least in part on the communication metric; and
display at least a portion of the plurality of contact identifiers on a display in the order.

21. The communications device of claim 20, wherein the at least one corresponding contact address comprises a telephone number.

22. The communications device of claim 20, wherein the communications device comprises a mobile phone, the communication interactions comprise telephone calls, and the at least one corresponding contact address comprises a telephone number.

23. A computer-implemented method performed on a communications server that is coupled to a communications device, comprising:
maintaining, by the communications server, a contacts directory comprising a plurality of contact entries, wherein each of the plurality of contact entries includes a corresponding contact identifier and at least one corresponding contact address;
maintaining, by the communications server, a communication metric for at least some of the plurality of contact entries based on communication interactions via the at least one corresponding contact address;
receiving, by the communications device, a request for the contacts directory from the communications device;
ordering, by the communications server, the plurality of contact identifiers in an order based at least in part on the communication metric; and
sending at least a portion of the plurality of contact identifiers in the order to the communications device responsive to the request.
